(19) United States
(12) Patent Application Publication
(10) Pub. No.: US 2021/0253409 A1
(43) Pub. Date: Aug. 19, 2021

(54) Vehicle Ramp

(71) Applicants: Harry J. Eckert, Copley, OH (US); James D. Bonner, Copley, OH (US)

(72) Inventors: Harry J. Eckert, Copley, OH (US); James D. Bonner, Copley, OH (US)

(21) Appl. No.: 17/151,150

(22) Filed: Jan. 16, 2021

Related U.S. Application Data
(60) Provisional application No. 62/961,804, filed on Jan. 16, 2020.

(51) Int. Cl. B66F 7/24

(52) U.S. Cl. CPC B66F 7/243

(57) ABSTRACT

A vehicle ramp is provided, having an adjustable ramp angle mechanism for use with and to accommodate vehicles, especially those having low ground clearance. The ramp has a wheel support formed at a top support surface and an inclined front surface. A recessed receiving channel is formed within the ramp and wheel support. An extension bridge is selectively removable from and fittingly received within a receiving channel. The bridge is extendable from the channel and from the inclined upper surface to form a ramp extension having a lower angle of approach than the inclined surface. This abstract is neither intended to define the invention disclosed in the specification, nor intended to limit the scope of the claims in any way.

### I. RELATED APPLICATIONS

This Utility patent application claims priority to previously-filed U.S. Provisional Patent Application Ser. No. 62/961,804 entitled “VEHICLE RAMP,” filed Jan. 16, 2020, and which is incorporated herein by reference.

### II. BACKGROUND OF THE INVENTION

### A. Field of the Invention

The invention generally relates to methods and apparatuses for temporarily raising a vehicle so that maintenance or inspection may be done under the vehicle, and more specifically to ramps upon which vehicles, such as cars or trucks, may be driven onto, thereby lifting a portion of the vehicle and allowing easier access to the vehicle's underside, and even more specifically, to vehicle ramps specifically designed for vehicles which have undersides riding lower to the ground and for which use of a conventional ramp might damage the vehicle.

### B. Description of Related Art

It is known for repairmen and vehicle owners to purchase ramps to elevate a portion of an associated vehicle above the ground to create more clearance, thereby allowing the ramp user easier access to the underside of the vehicle. For example, such ramps might be used to enable a ramp owner to change the oil in his car, to repair brakes, or check suspension or the like.

In an exemplary use, a pair of ramps are positioned on a flat, horizontal surface, such as a garage floor or driveway. The ramps are secured so they will not slide. The vehicle is driven up onto the ramps, most commonly with both front wheels of the vehicle or perhaps both rear wheels on the ramp. The user carefully aligns the ramps with the wheels of the vehicle and then slowly drives the vehicle up the inclined portion of the ramp to a flat portion where the vehicle is stopped and secured. Because the ramps are considerable higher than the road or other flat surface, the user can easily access the underside of the vehicle, engine, wheels, brakes, suspension, and the like.

Prior art vehicle ramps have typically been constructed of steel and were often painted. For the ramps to be strong enough to support vehicle weight, the ramps themselves tend to be heavy, and because of their size, they are not easily handled or stored.

The following references are known and are related to improvements in vehicle ramps and ramp systems.

U.S. Pat. Nos. 6,910,675; 4,920,596; 4,427,179; and 3,752,441.

Applicants believe improvements over the prior art ramps are desirable, especially for ramps that can accommodate higher performance vehicles with low ground clearance, or vehicles which have original equipment or after-market body panels, such as ground effects, air dams, and spoilers which make ramps more difficult to use.

The invention disclosed herein will provide advantages over the known prior art and this description will be readily understood by a person of skill in the art.

### III. SUMMARY

According to some embodiments of the invention, a ramp may include a wheel support, a top support surface, an inclined front surface, and an upper inclined surface. The ramp includes at least one channel, the channel is preferably aligned with the longitudinal axis of the ramp. The channel can have multiple receiving notches depending on the configuration of the vehicle with which it should be used.

The ramp further includes an extension bridge which can be selectively inserted or removed from the channel. The extension bridge has at least one locking hinge which can selectively cooperate with a receiving notch in the channel.

In one embodiment of the invention, a rotation enabling member can be selectively added to the ramp.

### IV. BRIEF DESCRIPTION OF THE DRAWINGS

The invention may take physical form in certain parts and arrangement of parts, embodiments of which will be described in detail in this specification and illustrated in the accompanying drawings which form a part hereof and wherein;

FIG. 1 is a perspective view of a ramp according to the invention;

FIG. 2 is a perspective view of a ramp according to the invention with an extension bridge (not shown);

FIG. 3 shows a perspective view of a ramp according to the invention with the extension bridge in a first position, or retracted position, and shows traction-enhancing elements on a top surface of the ramp and extension bridge;

FIG. 4 shows a perspective view of the ramp with the extension bridge in a second, or extended position;

FIG. 5 is a perspective view of an extension bridge according to the invention;

FIG. 6 is a top view of the ramp with the extension bridge in a first, or retracted position;

FIG. 7 is an end view of the ramp shown in FIG. 8;

FIG. 8 is a side schematic view of a ramp according to the invention showing geometric measurements and angle measurements to facilitate an understanding of the representative size and orientation;

FIG. 9 is a schematic view showing location of interior ribs and their location in the plastic embodiment of the invention;

FIG. 10 is a schematic view of the ramp shown in FIG. 8 with the extension bridge extended to a second position;

FIG. 11 is a perspective view of an associated vehicle with its right, front wheel located upon the top support surface of the wheel support;

FIG. 12 is a perspective view of an associated vehicle with its right, front tire ascending the extension bridge;

FIG. 13 is a side view of an associated vehicle with its right, front wheel beginning ascent on the extension bridge shown in the second, or extended position;

FIG. 14 is an end view of an embodiment of the invention, with the ramps shown with the extension bridges in the first, or retracted position;

FIG. 15 is a perspective view of an associated vehicle approaching the ramps;

FIG. 16 is a side view of an associated vehicle with its right, front wheel beginning to ascend the extension bridge of a ramp, with the extension bridge shown in the second, or extended position;

FIG. 17 is a side view of the inventive ramp;

FIG. 18 is a side view of two ramps shown stored in an associated garage;

FIG. 19 is a perspective view of two ramps according to the invention;

FIG. 20 is a listing of technical data helpful in the manufacturing process of a ramp according to the invention;

FIG. 21 is a listing of technical data helpful in the manufacturing process of a ramp according to the invention;

FIG. 22 is a tabular listing of technical data helpful in the manufacturing process of a ramp according to the invention;

FIG. 23 is a perspective, schematic view of a ramp according to the invention, showing the horizontal plane that divides the ramp into two portions;

FIG. 24 is a perspective, schematic view of a ramp according to the invention, showing the for cylindrically shaped holes adapted to selectively receive corresponding pegs;

FIG. 25 is a perspective, schematic view of a rotation-enabling member according to the invention, showing the pegs which can be selectively received into the cylindrically shaped holes shown in FIG. 24;

FIG. 26 is a perspective, schematic view of a rotation-enabling member according to the invention, selectively mounted onto the ramp;

FIG. 27 is a perspective, schematic view of riser blocks selectively mounted onto the ramp;

FIG. 28 shows a perspective view of an alternate embodiment riser block;

FIG. 29 shows a top view of an alternate embodiment riser block;

FIG. 30 shows a perspective, front view of an alternate embodiment riser block;

FIG. 31 shows a side view of an alternate embodiment riser block;

FIG. 32 shows a top, perspective view of the riser blocks in place on the ramp;

FIG. 33 shows a side view of the riser blocks in place on the ramp;

FIG. 34 shows a top perspective view of the ramp with a user's hand removing or installing one of the riser blocks;

FIG. 35 shows a top, perspective view of the ramp with one riser block removed and another riser block in place;

FIG. 36 shows a top, perspective view of the ramp with both riser blocks in place and the extension bridge extended;

FIG. 37 is a top perspective view of the rotation member 70 in place upon the ramp 10;

FIG. 38 is a top view of the rotation member 70 in place upon the ramp 10, also showing the extension bridge 40;

FIG. 39 is a top view of the rotation member removed from the ramp 10;

FIG. 40 is a side view of the rotation member 40.

### V. DETAILED DESCRIPTION

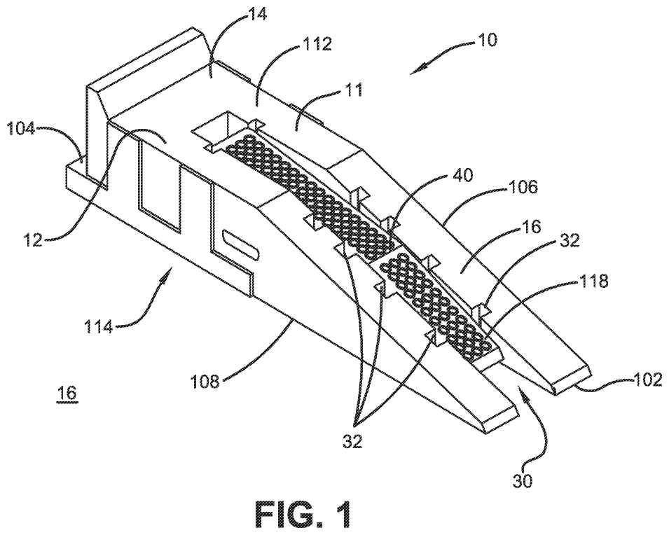

Referring now to the drawings wherein the showings are for purposes of illustrating embodiments of the invention only and not for purposes of limiting the same, and wherein like reference numerals are understood to refer to like components, FIGS. 1-27 show a ramp 10 according to the invention.

With reference to FIG. 1, a ramp 10 includes a front end 102, a back end 104, a right side 106, and a left side 108. The ramp 10 also includes a top side 112, and a bottom side 114. When the ramp 10 is being used as is intended, the bottom side 114 of the ramp 10 lays on an associated flat surface 116, such as a garage floor, cement driveway, or the like.

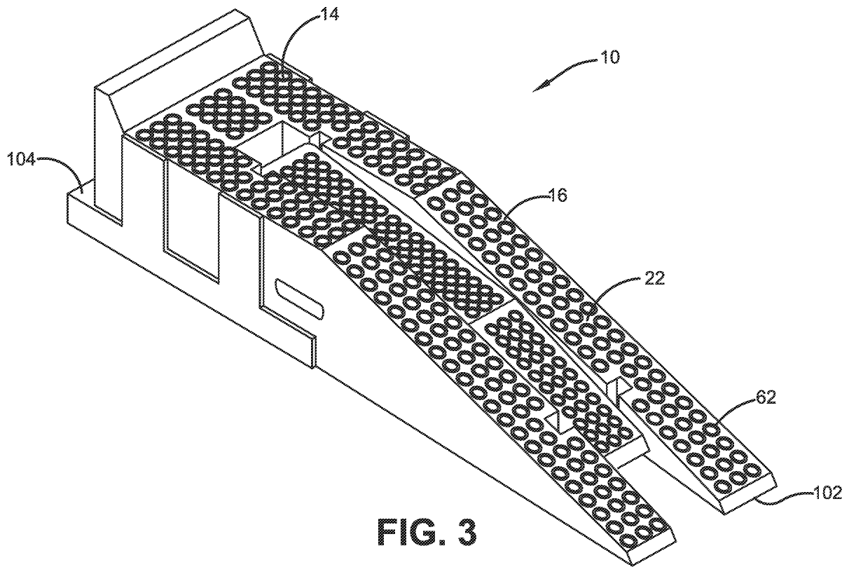

With continuing reference to FIGS. 1 and 3, the ramp 10 includes a wheel support 12 formed at a top support surface 14. As seen in FIG. 3, the top upper surface 20 may have traction enhancing surfaces 18. An inclined front surface 16 may also feature the traction enhancing surfaces 18.

With continued reference to FIG. 1, an extension bridge 40 selectively and removably fits within a channel 30.

With continuing reference to FIGS. 1-4, the ramp 10 as shown in various configurations to facilitate understanding. In FIG. 1, the ramp 10 is shown with the extension bridge 40 being in a first or retracted position. This is the sort of configuration where the ramp 10 would be suitable for most vehicles to be serviced and the angle “AAA” made between the associated flat surface 116 and the upper incline surface 22 is larger than the angle “BBB” made when the extension bridge makes with the associated flat surface, as will be described later.

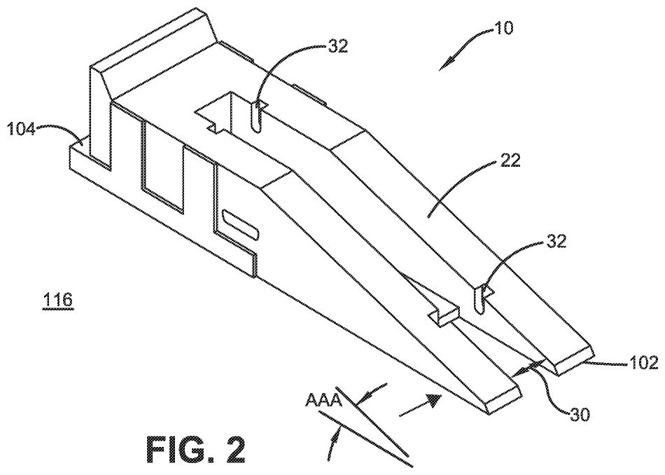

With reference to FIG. 2, the channel 30 is more clearly shown as the extension bridge 40 is not shown. The channel 30 is shown as parallel to the right side 106 and left side 108 of the ramp 10, but a parallel configuration is not necessary.

With reference to FIG. 3, the ramp 10 is again shown with the extension bridge 40 in a first, or non-extended position, but the upper incline surface 22 and inclined front surface 16 and the top support surface 14 are shown covered with traction-enhancing elements 62. If the ramp 10 is molded from an elastomer, such as TPE or polypropylene, one configuration of traction-enhancing elements 62 are hexagonal shaped extensions which extend upwardly from the upper surfaces of the ramp 10 a short distance, about one fourth inch. The traction-enhancing elements 62 can be of a variety of styles or types chosen with sound engineering judgement. A currently preferred traction-enhancing elements 62 are elastomeric from either plastic or hard rubber, having a generally hexagonal or circular configuration. The same shape works well with metal ramps 10.

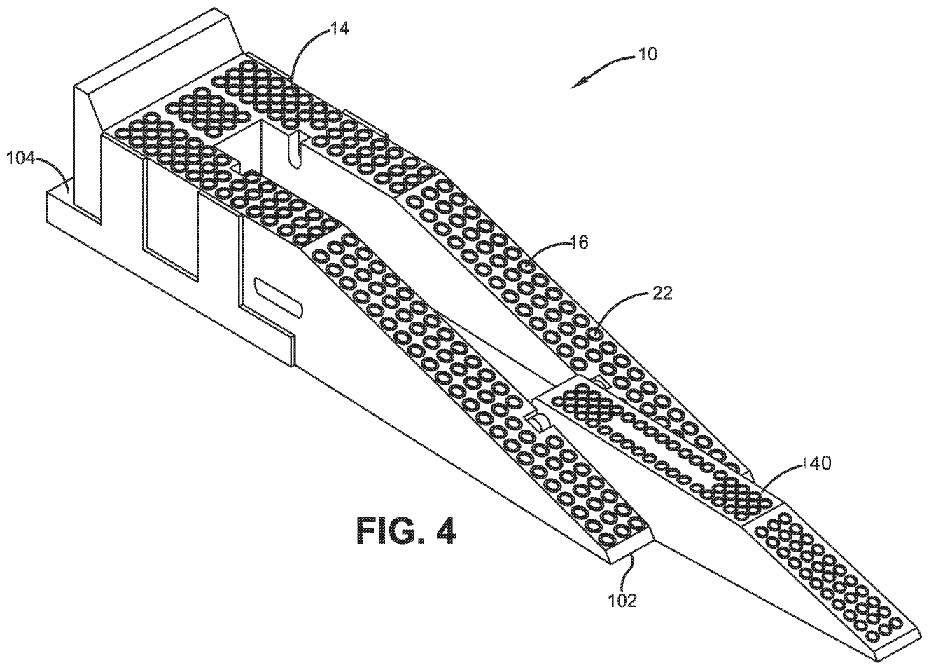

With reference to FIG. 4, the extension bridge 40 is shown in a second, or extended configuration. With reference to FIG. 2, notches 32 are shown on opposite sides of channel 30. As shown in FIG. 1, several pairs of notches 32 can be configured into the ramp 10 on the sides facing the channel 30. The notches can receive a locking hinge 42, with the preferred relationship being a pair of notches, opposite each other, receiving a pair of locking hinges.

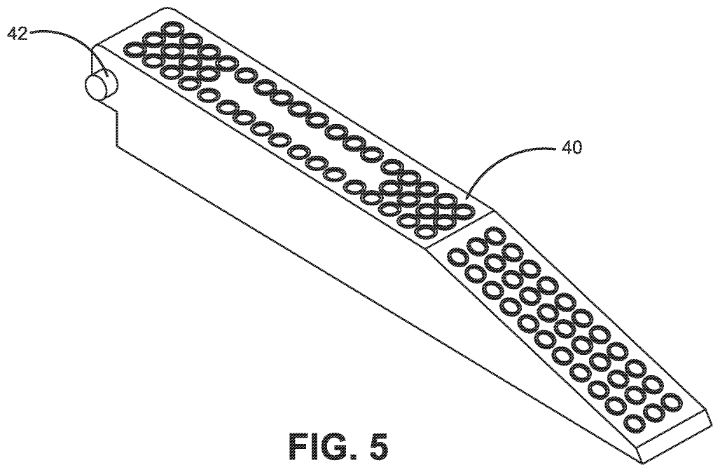

With reference to FIG. 5, the extension bridge 40 is more clearly shown along with the locking hinge 42.

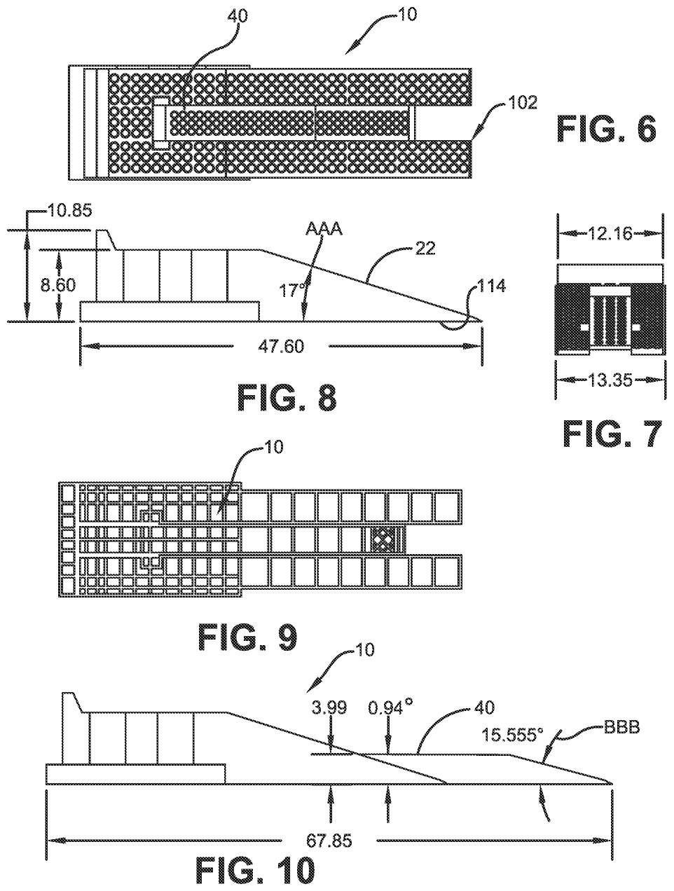

With reference to FIGS. 6 through 11, additional information about the ramp 10 is shown.

FIG. 6 is a schematic top view of the ramp 10 with the extension bridge 40 shown in the first, or retracted position.

FIG. 7 shows an end view of the ramp 10 with representative dimensions. In one preferred embodiment, the top width of the ramp 10 is 12.16 inches, while the bottom is 13.35 inches. Similarly, with reference to FIG. 8, dimensions are shown in one preferred embodiment. The angle made by the upper inclined surface 22 and with the bottom side 114 is herein called “AAA.” In a preferred embodiment, when the extension bridge 40 is in a first, retracted position, the angle “AAA” is about 17°, as is shown in FIG. 8. With continued reference to FIG. 8, the user will see that the overall length of the preferred embodiment is 47.6 inches, and the height of various aspects of the ramp 10 are also shown such as 8.6 inches and 10.85 inches.

With reference to FIG. 9, a view of the internal support mechanisms is shown. In one preferred embodiment, the ramp 10 is manufactured of an elastomer, such as high-strength plastic, and the ramp 10 is strengthened by configuring a series of rectangular modules into the ramp 10 when molded.

With reference to FIG. 10, a helpful comparison can be made between the ramp 10 in the first, retracted position, as shown in FIG. 8, and a second, extended position as shown in FIG. 10. In FIG. 10, the extension bridge 40 is extended so that the entire overall length of the ramp 10 is now 67.85 inches and the angle of attack (angle “BBB”) of the front edge of the extension bridge 40 is 15.55°, as compared to the angle “AAA” which was 17° of FIG. 8.

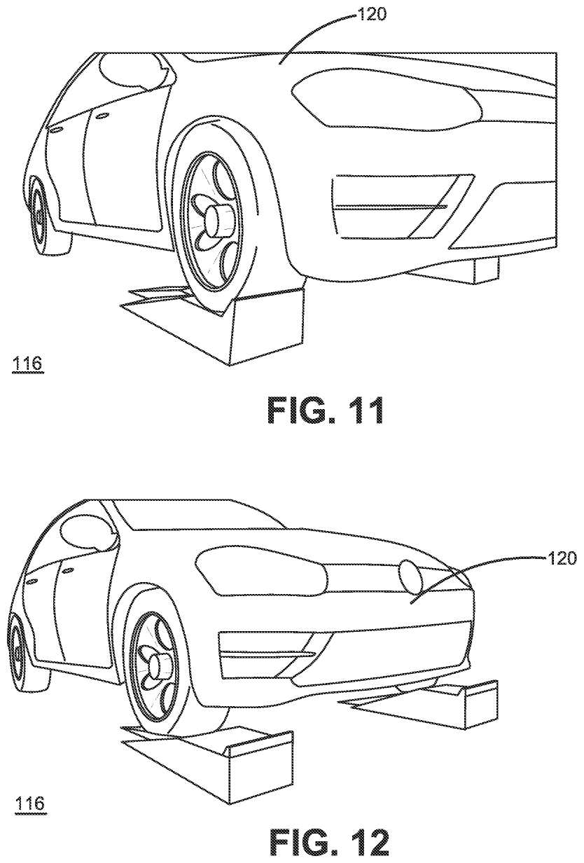

With reference to FIG. 11, an associated vehicle in FIG. 11, the associated vehicle's 120 right, front wheel is shown being supported by the top support surface 14.

With reference to FIG. 12, the associated vehicle 120 is shown with its right, front wheel ascending the upper incline surface 22 of the ramp 10.

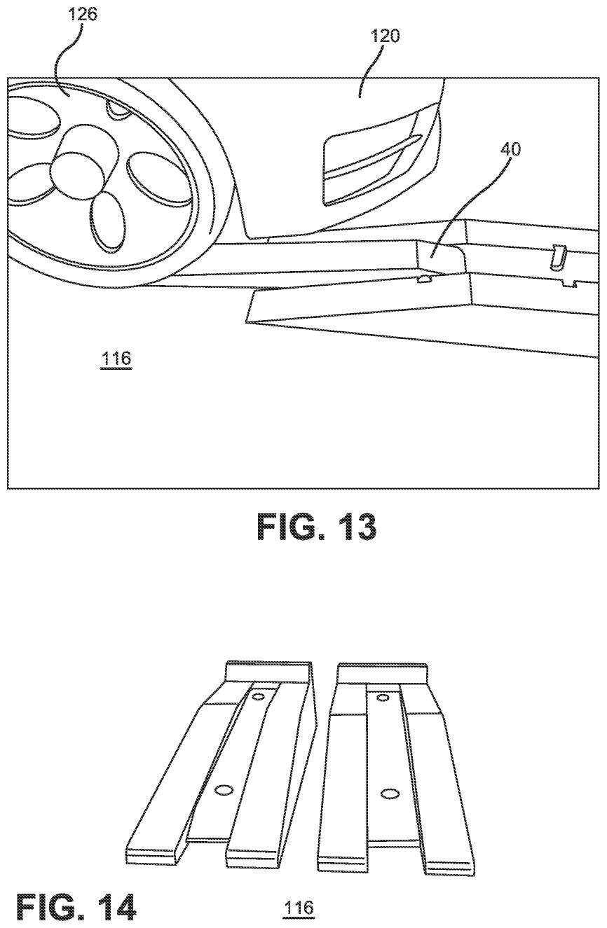

With reference to FIG. 13, the right front wheel 126 of the associated vehicle 120 is shown beginning ascent of the extension bridge 40 shown in the second, or extended position. The locking 42 is clearly visible.

With reference to FIG. 14, an end view of a pair of ramps 10 is shown, with the extension bridge 40 shown in the retracted, or first position.

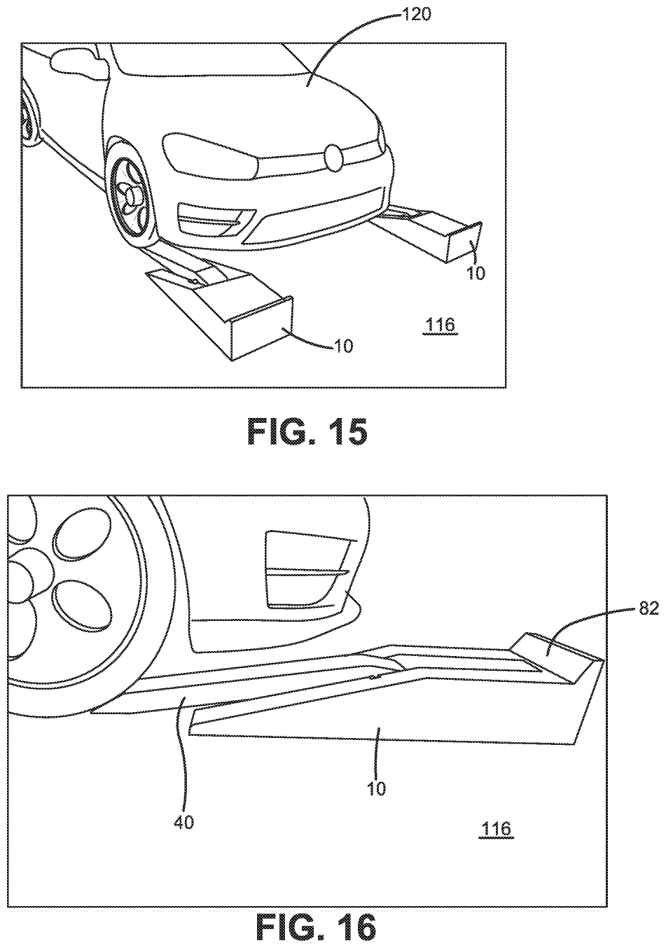

With reference to FIG. 15, the associated vehicle 120 is shown approaching a pair of ramps 10.

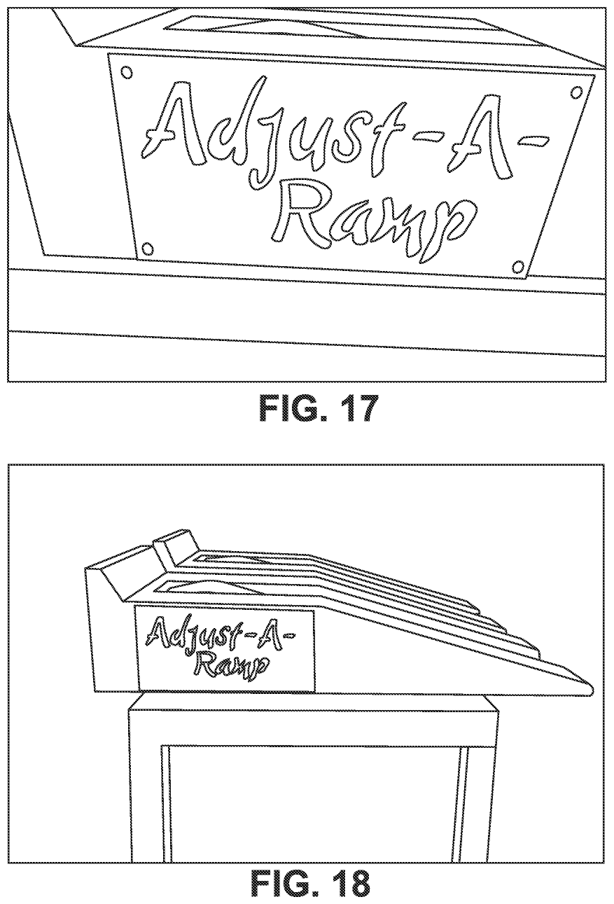

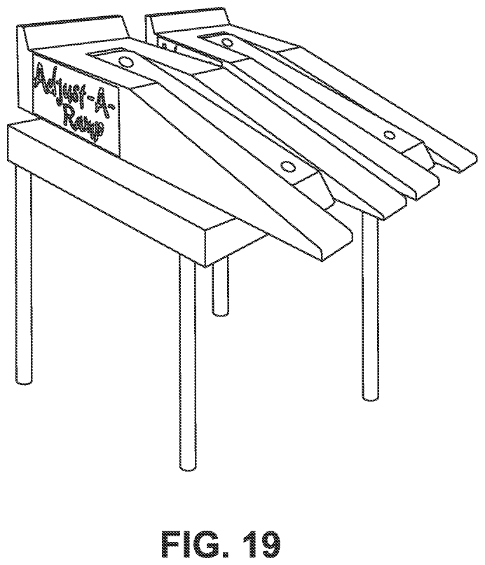

With reference to FIG. 16, the associated vehicle 120 is shown with its right, front wheel 126 beginning the ascent of the extension bridge 40.

With reference to FIGS. 17 and 18, a side view of the ramps 10 is shown. Note that the ramp 10 provides side surfaces 106,108, suitable for receiving indicia, such as the name of the garage or the like.

FIG. 19 shows a pair of ramps 10 according to the invention stored in a garage. Note the preferred embodiment ramp 10 includes first backstop 82 which can assist the driver of the associated vehicle 120 in sensing when the vehicle wheel is in position upon the ramp 10.

With reference to the materials and manufacturing methods of the preferred embodiment, it is known that the ramp 10 can be made of a variety of materials, although the currently preferred material is an elastomer, specifically polypropylene. Applicants performed considerable work to determine how polypropylene can be configured to effectively carry the load necessary for the ramp's operative function. In this disclosure, we have already described the configuration of squares or smaller units with dividing walls as shown in FIG. 9. This configuration strengthens the ramp 10, especially when made from a thermoplastic elastomer.

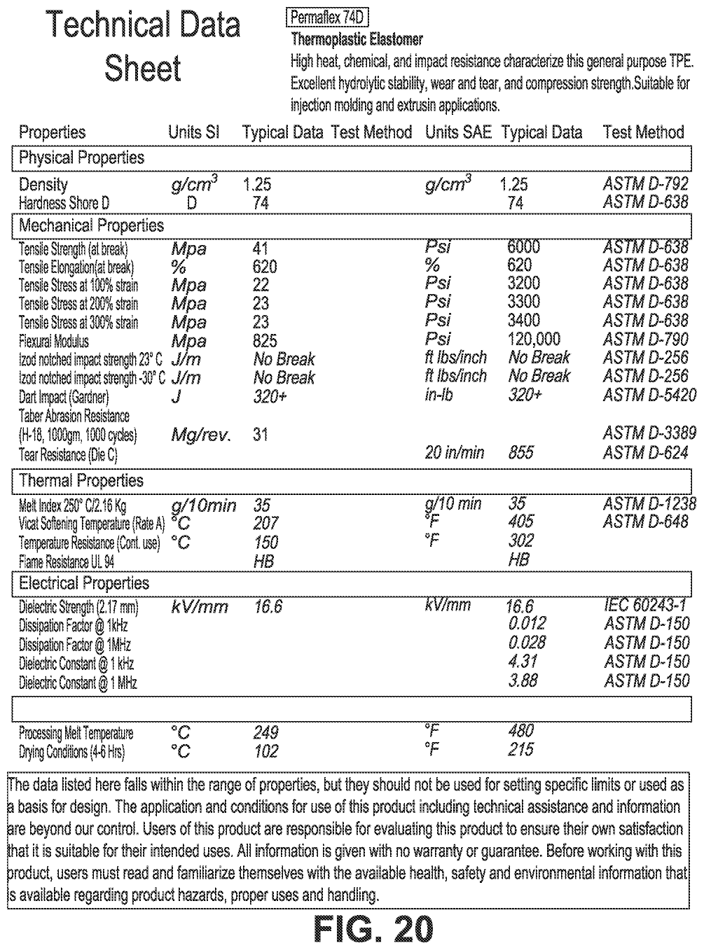

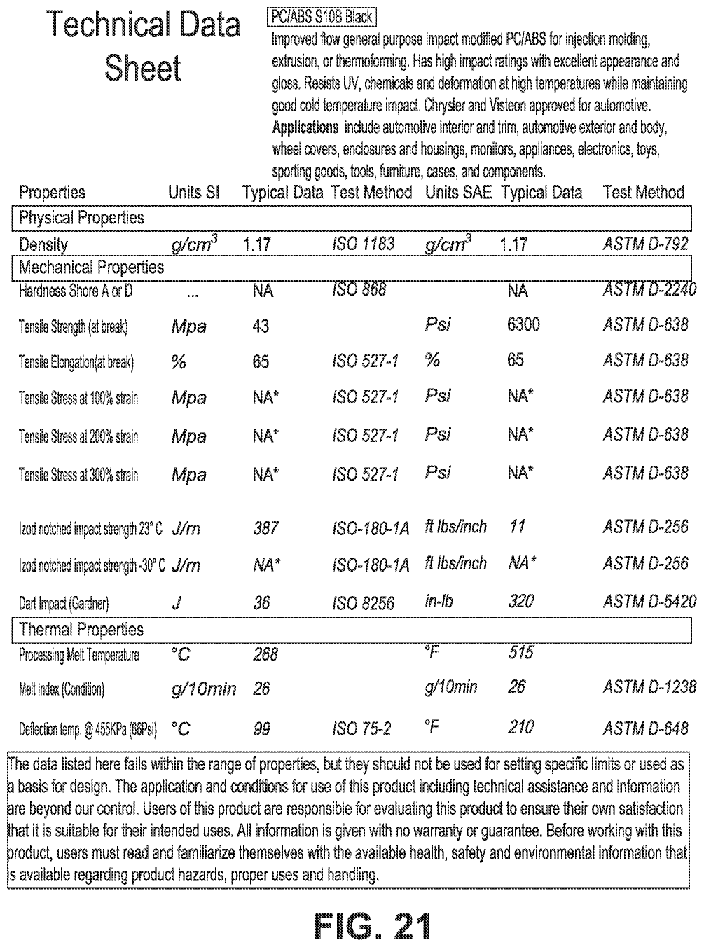

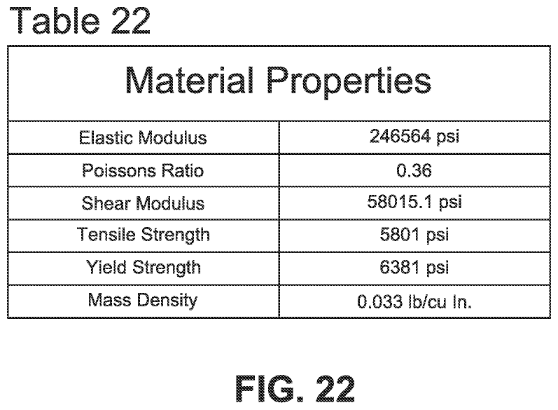

With reference to FIGS. 20 and 21, technical data concerning the use of a thermoplastic elastomer is shown. Using this elastomer, and this design, the load was appropriately distributed over the ramp 10 to keep stresses safely below the yield stress of the material which was 6,381 pounds per square inch. The properties of the material chosen is shown in FIG. 22.

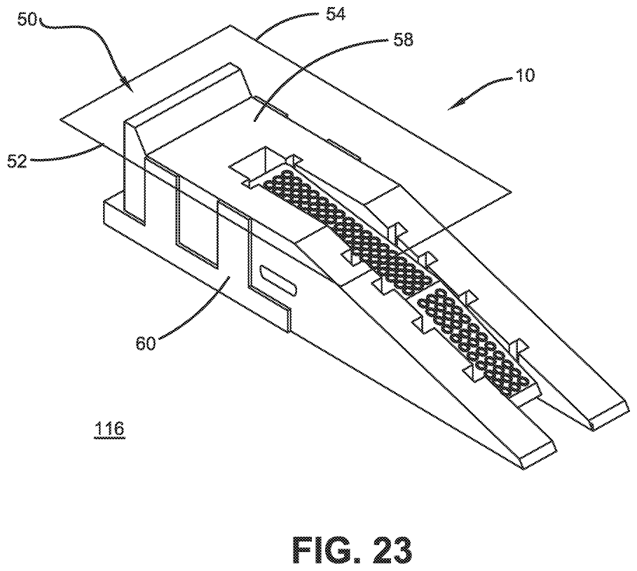

With reference to FIG. 23, a horizontal plane 50 is defined by lines 52 and 54. Plane 50 essentially bisects the ramp 10 at its highest portion in a horizontal direction, essentially cutting the ramp 10 into two portions. In the preferred manufacturing method, polypropylene material is used to manufacture the ramp 10. In the preferred manufacturing method, two molds are used to speed manufacture time and cure time, as well as quality. The ramp 10 is manufactured preferably as a top half 58 and a bottom half 60.

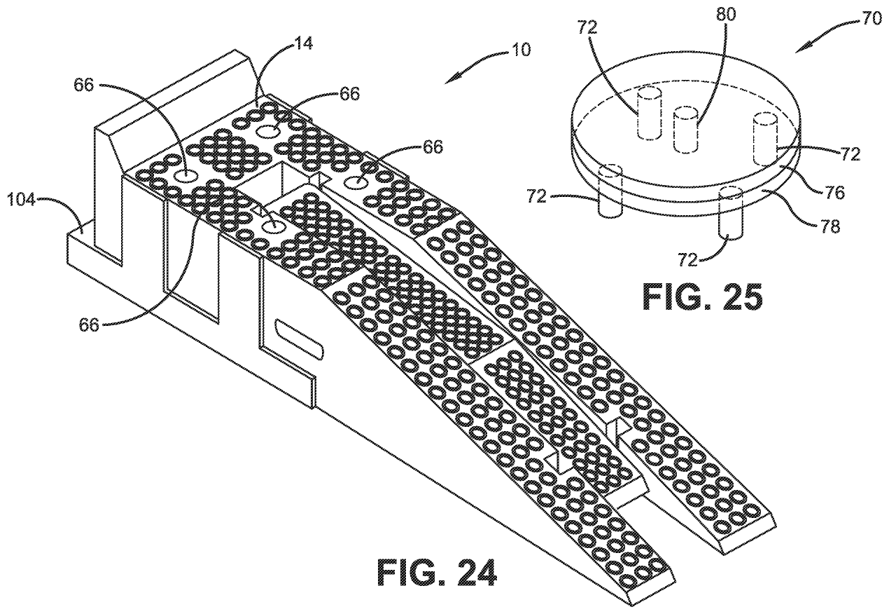

With reference to FIGS. 24-26, another feature of the invention will be described. With reference to FIGS. 24 and 25, an exploded view of the invention is shown. FIG. 24 shows the ramp in its normal configuration. However, note on the top support surface 14, the presence of four holes 66. The holes 66 are cylindrically shaped and can selectively receive associated pegs 72 and shown in FIG. 25. In the preferred embodiment, there are four holes 66 which correspond to the four pegs 72. With continued reference to FIG. 25, the rotation enabling member 70 comprises an upper disk 76 and a lower disk 78. The lower disk 78 does not rotate but is instead secured to the top support surface 14 via the insertion of pegs 72 into holes 66. But such selective insertion, the rotation enabling member 70 is secured to the ramp 10. However, the upper disk 76 can rotate angularly relative to the lower disk 78 by virtue of an axle 80. Rotation of the upper disk 76 does not need to be 360° rotation, as the available rotation of the rotation disk 76 can match the angular ration capabilities of the associated tire on the associated vehicle 120. The purpose of the rotation enabling member 70 is to allow a user to turn the vehicle wheels to the right or the left and thereby provide better access to the portion of the vehicle under consideration, without the ramp 10 shifting position. For example, by driving an associated vehicle on to the ramp 10 so that the vehicle's front tires are located on to the rotation enabling members 70, the vehicle wheels 126 could then be turned to the right or the left and the wheels could be able to freely turn, allowing the user to access brakes, suspension, etc. without requiring the ramp 10 to move angularly.

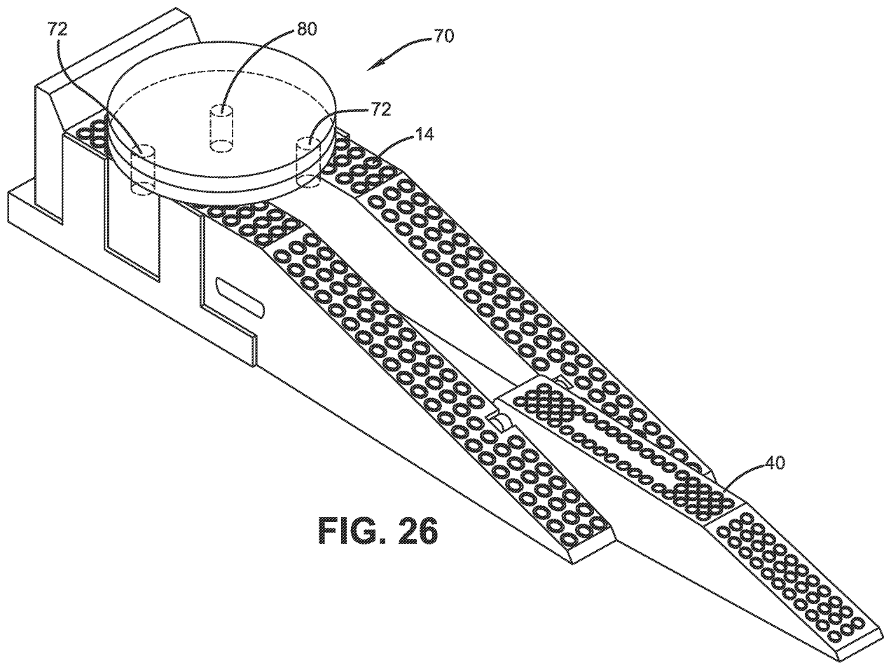

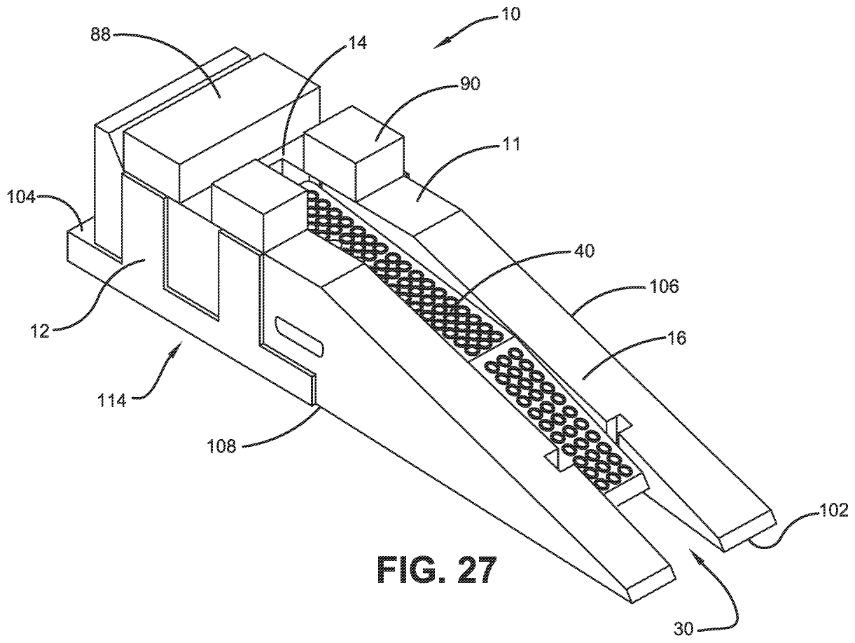

With reference to FIG. 26, a schematic view of the rotation enabling member 70 mounted in place onto the ramp 10 is shown. With reference to FIG. 27, another embodiment of the invention is shown. In FIG. 27, a new element, riser blocks 88 and 90 are shown. These riser blocks can be fitted into the same holes 66 shown in FIG. 24. The preferred riser block configuration includes a first block 88 and a second block 90 but a single block can also be used. The riser block simply raises the vehicle tire an additional amount of space above the normal ramp 10 configuration if this is necessary or helpful. For example, with reference to FIGS. 8 and 10, the height of the ramp 10 is seen to be about 8.6 inches. However, by use of riser blocks 88,90, an additional amount of height can be selectively added. The current riser blocks 88,90 add two inches in height, although different riser blocks in different configurations can adjust the height as desired.

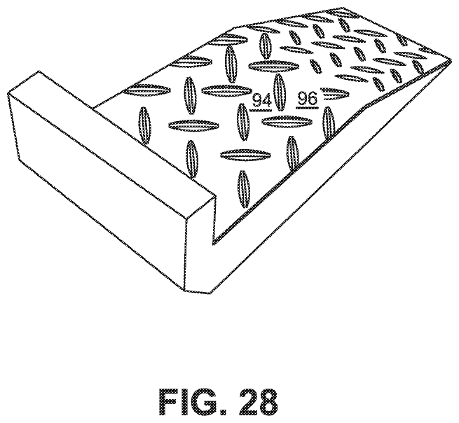

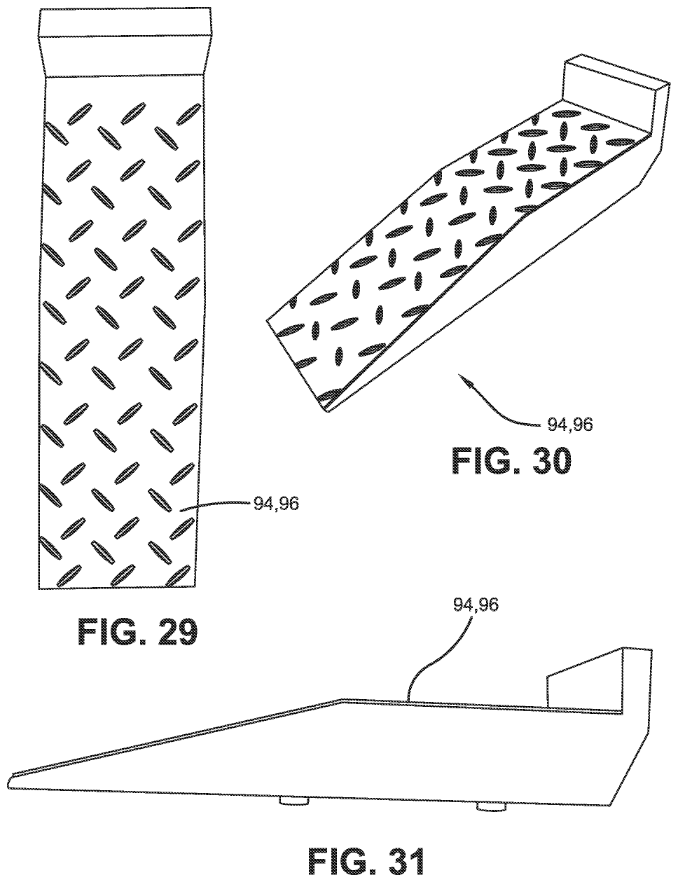

With reference to FIGS. 28-31, another embodiment of the riser blocks 94, 96 is shown. FIG. 28 shows a perspective view of a riser block 94, FIG. 29 shows a top view of a riser block 94, FIG. 30 shows a perspective, front view of a riser block 94, and FIG. 31 shows a side view of a riser block 94.

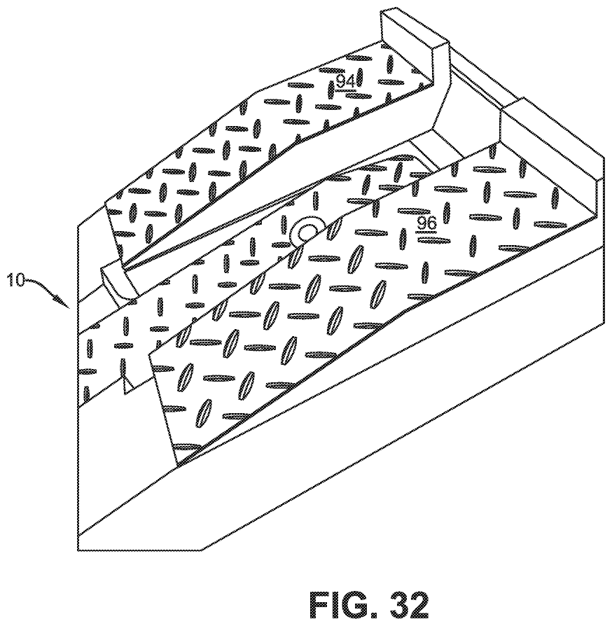

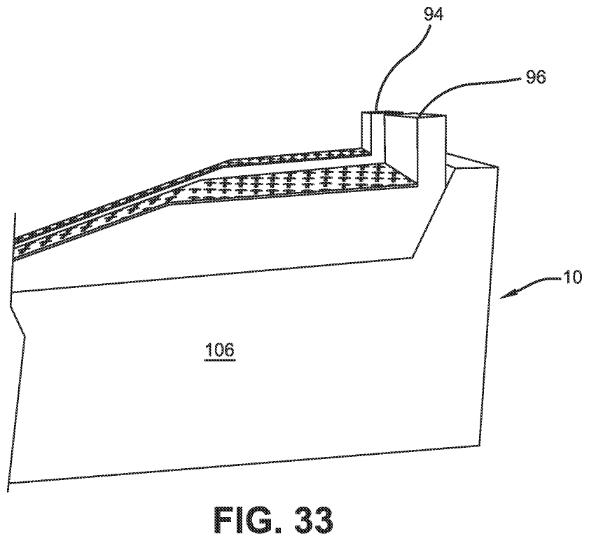

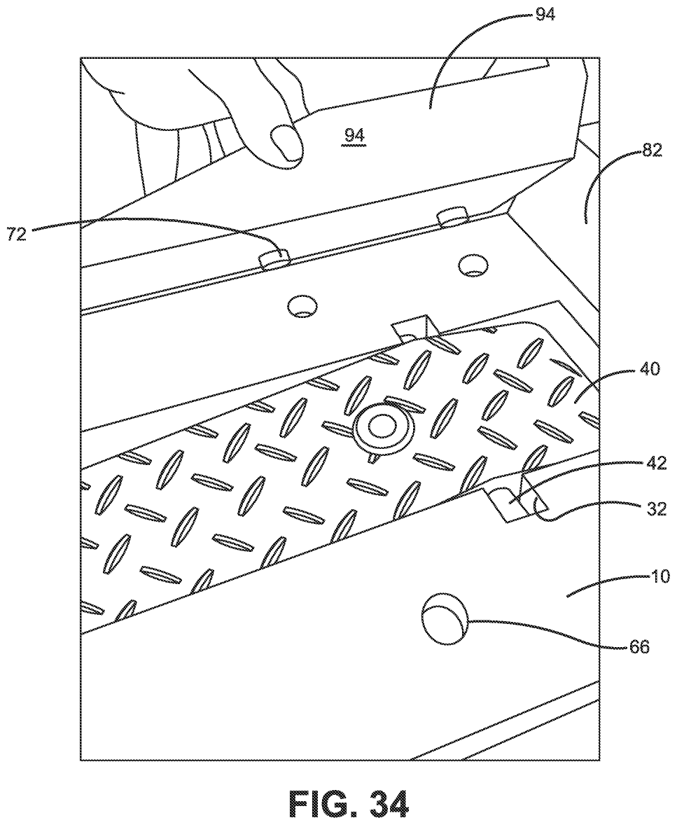

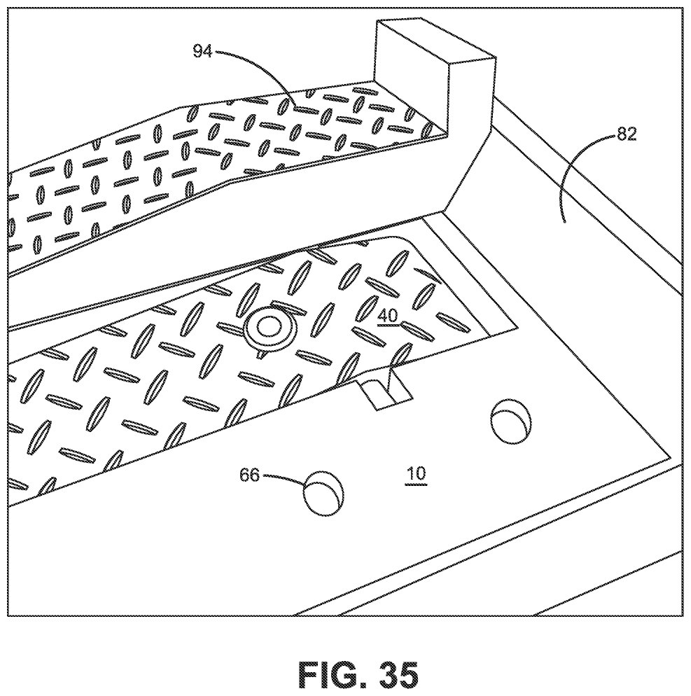

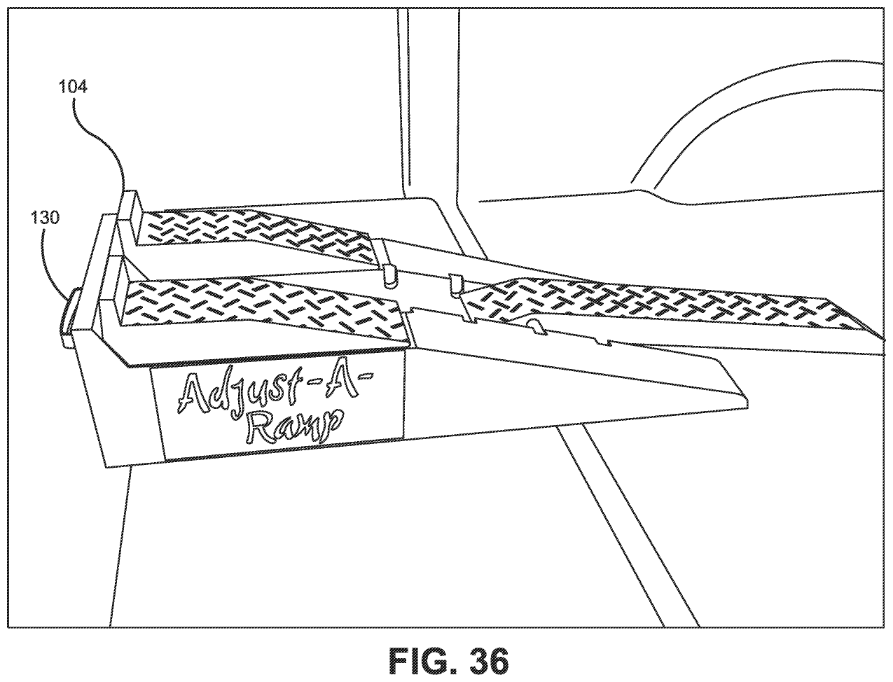

With reference to FIGS. 32-36, the operation of the riser blocks 94, 96 will be described. FIG. 32 shows the riser blocks 94, 96 in position. While the riser blocks 94, 96 can be configured to selectively raise the elevation of the ramp 10 various amounts of height, the riser blocks 94, 96 shown in FIGS. 32-36 raise the elevation of the associated tire an additional two inches above the associated flat surface 116. FIG. 33 shows a side view of the ramp 10 with the riser blocks 94, 96 in position. Also shown in FIG. 33 is a plaque 100 that is optionally provide for indicia, such as advertising. With reference to FIG. 34, the ramp 10 is shown with riser block 96 removed so that hole 66 is clearly seen. The riser blocks 94, 96 have pegs 72 that can be selectively received into cylindrically shaped holes 66. As shown in FIG. 34, the riser blocks 94, 96 can be selectively removed or added to the ramp 10 by manually generated forces. FIG. 35 shows a perspective view of the ramp 10 with one riser block 94 mounted onto the ramp 10 and the other riser block 96 removed. FIG. 36 shows an elevated, perspective view of the ramp 10 with the riser blocks 94, 96 installed and the extension bridge 40 in the extended position. In FIG. 36, the ramp 10 is shown in the back of a pickup truck, illustrating the excellent portability of the ramp 10. With continuing reference to FIG. 36, in one embodiment, a U-shaped handle 130 is advantageously mounted at the back end 14 of the ramp 10.

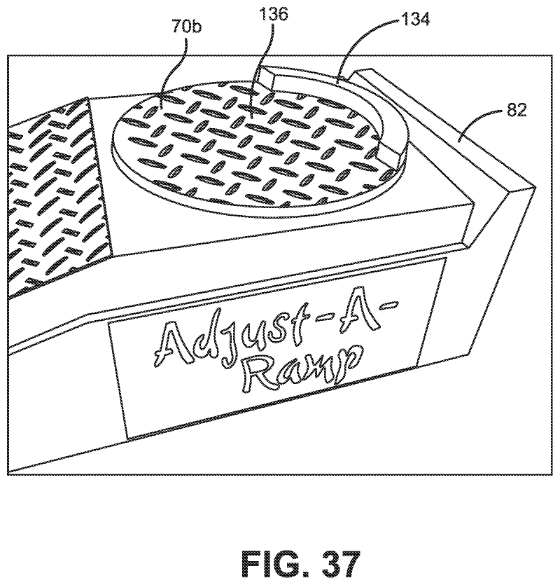

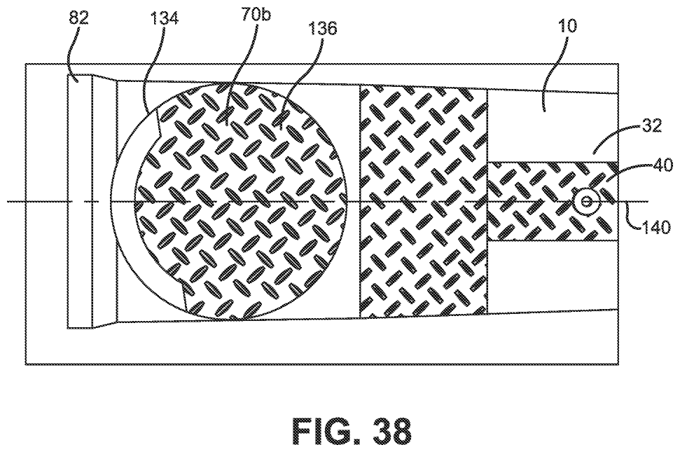

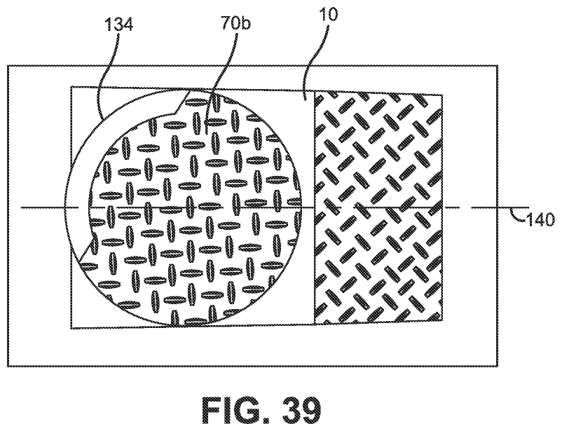

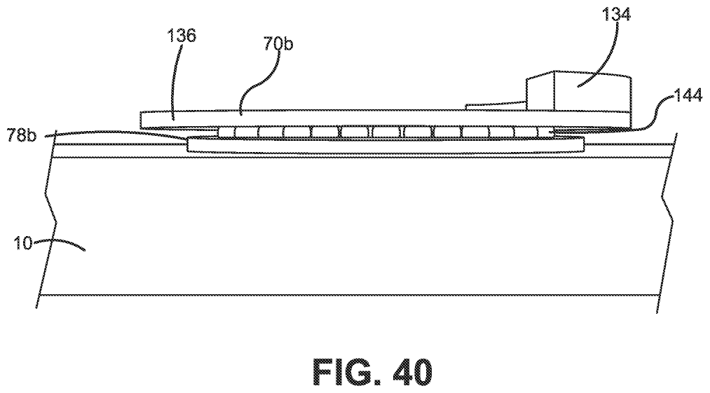

With reference to FIGS. 37-40, another embodiment of the rotation member 70b will be described. FIG. 37 is a top perspective view of the rotation member 70b in place upon the ramp 10. FIG. 38 is a top view of the rotation member 70b in place upon the ramp 10, also showing the extension bridge 40. FIG. 39 is a top view of the rotation member 70b removed from the ramp 10. FIG. 40 is a side view of the rotation member 70b.

With reference to FIG. 37, the rotation member 70b is shown in a first or neutral position, such as would be the position with the associated tire of the associated vehicle 120 drove up the ramp 10 and onto the rotation member 70b. Note that a second backstop 134 is arcuately shaped and secured to the top surface 136 of the rotation member 70b.

FIG. 38 is a top view of the ramp 10 with the rotation member 70 in place. Depending on the diameter of the rotation member 70b, the length and width of the ramp 10 may need to be increased from the dimensions shown in FIGS. 8 and 10.

FIG. 39 shows the rotation member 70b disassembled from the ramp 10. In this view, the rotation member 70b is shown slightly angularly displaced, as is best seen by noting the position of the second backstop 134. In operation, when the vehicle is driven onto the ramp 10 and the rotation member 70b, the rotation member 70b and the associated tire are in the neutral position, as shown in FIGURE the associated tire 126 of the associated vehicle 120 drove up the ramp 10 and onto the rotation member 70b. With reference to FIG. 38, a longitudinal centerline 140 of the ramp 10 essentially bisects the second backstop 134 when it is in the neutral position. However, as shown in FIG. 39, the rotation member 70b has rotated to a second position, angularly displaced from the neutral position.

With reference to FIG. 40, the rotation member 70b is shown in a side view. Note that the rotation member 70b comprises an upper disk 76b and a lower disk 78b. In this embodiment, the lower disk 78b equipped with ball-bearings 144.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof. Further, the “invention” as that term is used in this document is what is claimed in the claims of this document. The right to claim elements and/or sub-combinations that are disclosed herein as other inventions in other patent documents is hereby unconditionally reserved

Having thus described the invention, it is now claimed:

1. A vehicle ramp comprising an adjustable ramp angle mechanism for use with associated vehicles.

2. A vehicle ramp comprising at least one wheel support formed at a top support surface;
an inclined front surface extending upwardly to the top support surface;
a recessed channel receiving channel formed about the top upper surface and inclined upper surface; and
an extension bridge that is removable from and fittingly received within the receiving channel, wherein the bridge when extended from the channel from the inclined upper surface forms a ramp extension having a lower angle of approach than the inclined front surface.

3. The vehicle ramp of claim 2, wherein said receiving channel further forms a linearly aligned plurality of opposing receiving notches; and a locking hinge affixed near a distal end of extension bridge and extending outwardly from the sides of the extension bridge such that the locking hinge is receivable with any of a series of receiving notches.

4. A ramp comprising:
a first angled approach surface having a first approach angle, said first approach angle being formed by the intersection of said first angled approach surface and an associated flat surface;
a channel formed in the ramp;
an extension bridge selectively and moveably received in said channel of the ramp;
the extension bridge having a locking hinge selectively received into a first receiving notch and selectively received into a second receiving notch in said channel; a second approach angle being formed by the intersection of said extension bridge and the associated flat surface; said first approach angle being greater than said second approach angle.

7. A ramp configured to receive and support an associated vehicle and a wheel of the associated vehicle, the ramp comprising:
a rotation member having an upper disk that is angularly rotatable relative to a lower disk.

8. A ramp configured to receive and support an associated vehicle and a wheel of the associated vehicle, the ramp comprising:
a riser block selectively attachable onto an upper surface of the ramp, having an upper disk that is angularly rotatable relative to a lower disk.
